(19) United States
(12) Patent Application Publication
(10) Pub. No.: US 2025/0065721 A1
(43) Pub. Date: Feb. 27, 2025

(54) CONTROL CIRCUIT OF BMS, BATTERY MANAGEMENT SYSTEM, AND ELECTRIC VEHICLE

(71) Applicant: EVE ENERGY CO., LTD., Huizhou (CN)

(72) Inventors: Zhen LIU, Huizhou (CN); Wenbing XIAO, Huizhou (CN); Shaowei XIE, Huizhou (CN); Liping WAN, Huizhou (CN)

(73) Assignee: EVE ENERGY CO., LTD., Huizhou (CN)

(21) Appl. No.: 18/814,518

(22) Filed: Aug. 25, 2024

(30) Foreign Application Priority Data
Aug. 25, 2023 (CN) 202311087511.7
Aug. 25, 2023 (CN) 202322310166.0

(51) Int. Cl. B60L 3/00

(52) U.S. Cl. CPC B60L 3/0046; B60L 2270/20

(57) ABSTRACT

A control circuit of a BMS, a battery management system, and an electric vehicle are provided. The control circuit of the BMS may include: a charge-discharge switching module, a freewheel module, and a control module, where the charge-discharge switching module is connected between a battery and a load; the freewheel module is connected in parallel with the load; the control module is connected to the charge-discharge switching module and the freewheel module, respectively, and configured to generate a first control signal and a second control signal; the charge-discharge switching module is configured to be turned off in response to the first control signal; and the freewheel module is activated in response to the second control signal when the charge-discharge switching module is turned off.

### CROSS REFERENCE TO RELATED APPLICATIONS

This application claims priority to Chinese Patent Application No. 202311087511.7, filed with the Chinese Patent Office on Aug. 25, 2023, disclosure of which is incorporated herein by reference in its entirety.

### TECHNICAL FIELD

The present disclosure relates to the field of battery technologies, and more particular to a control circuit of a BMS, a battery management system, and an electric vehicle.

### BACKGROUND

With the development of the battery technologies, there is an increasing demand for an electric vehicle. Conventional automotive 12V lithium batteries are increasingly used in electric vehicles. A larger oscillation current may occur in a process for switching a charging loop and a discharging loop of a battery at a moment of disconnection of the loop due to a parasitic inductor of the battery, which may seriously damage a device of the loop. Since an electric vehicle is first started, a high-power Transient Voltage Suppressor (TVS) transistor is generally used for a solution of suppressing the current, has a limited energy absorption capacity and is easily damaged.

An impact current generated due to suddenly stopping charging or discharging an electric vehicle easily causes a damage to a device.

### SUMMARY

Some embodiments of the present disclosure provide a control circuit of a Battery Management System (BMS), a battery management system, and an electric vehicle, which can effectively reduce a damage to a device resulting from an impact current generated due to suddenly stopping charging or discharging an electric vehicle.

The present disclosure adopts technical solutions as follows.

Some embodiments of the present disclosure provide a control circuit of a BMS, including: a charge-discharge switching module connected between a battery and a load; a freewheel module connected in parallel with the load; and a control module connected to the charge-discharge switching module and the freewheel module, respectively, and configured to generate a first control signal and a second control signal; where the charge-discharge switching module is configured to be turned off in response to the first control signal; and where the freewheel module is configured to be activated in response to the second control signal when the charge-discharge switching module is turned off.

Alternatively, the freewheel module may include: a switching unit having both a first end connected to a first end of the load and a second end connected to a second end of the load; and a driving unit having a first end connected to a first electrode of the battery, a second end being grounded, an input end connected to the control module, and an output end connected to a control end of the switching unit; where the driving unit is configured to generate a driving signal in response to the second control signal of the control module, and output the driving signal to the switching unit; and where the switching unit is configured to be turned on in response to the driving signal.

Alternatively, the load may include: an external equivalent load and a parasitic equivalent inductor connected in series with the external equivalent load; the switching unit includes a first switching unit and a second switching unit; the driving unit includes a first driving unit and a second driving unit; a first end of the first switching unit is connected to a first end of the parasitic equivalent inductor, a second end of the first switching unit is connected to a first end of the second switching unit, and a control end of the first switching unit is connected to an output end of the first driving unit; a second end of the second switching unit is grounded, and a control end of the second switching unit is connected to an output end of the second driving unit; a first end of the first driving unit is connected to a first end of the second driving unit for connection to the first electrode of the battery, and both a second end of the first driving unit and a second end of the second driving unit are grounded; and both a control end of the first driving unit and a control end of the second driving unit are connected to the control module.

Alternatively, the first driving unit may include: a first switch transistor, a second switch transistor, a first resistor, a second resistor, a third resistor, and a fourth resistor; a first end of the first switch transistor is connected to a control end of the second switch transistor, a second end of the first switch transistor is grounded, the first resistor is connected between a second end of the first switch transistor and a control end of the first switch transistor, and the second resistor is connected between the control end of the first switch transistor and the control module; a first end of the second switch transistor is connected to the first electrode of the battery, and the second end of the second switch transistor is connected to the control end of the first switching unit; and the third resistor is connected between the first end of the first switch transistor and the control end of the second switch transistor, and the fourth resistor is connected between the first end of the second switch transistor and the control end of the second switch transistor.

Alternatively, the first switching unit may include: a first freewheel switch transistor, a fifth resistor, a sixth resistor, and a first capacitor; a first end of the first freewheel switch transistor is configured as the first end of the first switching unit, a second end of the first freewheel switch transistor is configured as the second end of the first switching unit, and a control end of the first freewheel switch transistor is connected to the output end of the first driving unit; the fifth resistor is connected between the control end of the first freewheel switch transistor and the output end of the first driving unit; and the sixth resistor and the first capacitor are connected in parallel between the control end and the second end of the first freewheel switch transistor.

Alternatively, the second driving unit may include: a third switch transistor, a fourth switch transistor, a seventh resistor, an eighth resistor, a ninth resistor, a tenth resistor, and a second capacitor; a first end of the third switch transistor is connected to a control end of the fourth switch transistor, a second end of the third switch transistor is grounded via the second capacitor, the seventh resistor is connected between the second end of the third switch transistor and the control end of the third switch transistor, and the eighth resistor is connected between the control end of the third switch transistor and the control module; a first end of the fourth switch transistor is connected to the first electrode of the battery, and a second end of the fourth switch transistor is connected to a control end of the third switch transistor; and the ninth resistor is connected between the first end of the third switch transistor and a control end of the fourth switch transistor, and the tenth resistor is connected between the first end of the fourth switch transistor and a control end of the fourth switch transistor.

Alternatively, the second switching unit may include: a second freewheel switch transistor, an eleventh resistor, a twelfth resistor, and a third capacitor; a first end of the second freewheel switch transistor is configured as the first end of the second switching unit, a second end of the second freewheel switch transistor is configured as the second end of the second switching unit, and a control end of the second freewheel switch transistor is connected to the output end of the second driving unit; the eleventh resistor is connected between the control end of the second freewheel switch transistor and the output end of the second driving unit; and the twelfth resistor and the third capacitor are connected in parallel between the control end and the first end of the second freewheel switch transistor.

Alternatively, the charge-discharge switching module may include: a charge switch transistor, a discharge switch transistor, a first diode, a second diode, and a thirteenth resistor; a first end of the charge switch transistor is connected to the load, a second end of the charge switch transistor is connected to a first end of the discharge switch transistor, a second end of the discharge switch transistor is connected to the battery, and a control end of the charge switch transistor is connected to the control module; an anode of the first diode is connected to the second end of the charge switch transistor, and a cathode of the first diode is connected to the first end of the charge switch transistor; an anode of the second diode is connected to the first end of the discharge switch transistor, and both a cathode of the second diode and the second end of the discharge switch transistor are connected to the first electrode of the battery; a control end of the discharge switch transistor is connected to the control module; and the thirteenth resistor and the second diode are connected in parallel between the first end and the second end of the discharge switch transistor.

Alternatively, the switching unit may include an Metal Oxide Semiconductor (MOS) transistor, and the driving unit may include a triode; and the charge-discharge switching module may include an MOS transistor.

According to a second aspect of the present disclosure, some embodiments of the present disclosure provide a battery management system: including the control circuit of the BMS according to any one of the first aspects.

According to a third aspect of the present disclosure, some embodiments of the present disclosure provide an electric vehicle, including: the control circuit of the BMS according to any one of the first aspects, or the battery management system according to any one of the second aspects.

The control circuit of the BMS according to the embodiments of the present disclosure includes: the charge-discharge switching module connected between the battery and the load; and the freewheel module connected in parallel with the load. At the moment when the charge-discharge switching module is turned off, the freewheel module is activated in response to the second control signal when the charge-discharge switching module is turned off. As such, a loop may be formed by the load and the freewheel module to provide a current discharging loop for an instantaneous high current generated at the moment when the charge-discharge switching module is turned off, and preferably prevents the instantaneous high current from impacting the charge-discharge switching module. As such, the control circuit of the BMS can effectively reduce a damage to a device resulting from an impact current generated due to suddenly stopping charging or discharging an electric vehicle.

### DESCRIPTION OF THE DRAWINGS

FIG. 1 shows a schematic structural diagram of a control circuit of an BMS according to some embodiments of the present disclosure.

FIG. 2 shows a schematic structural diagram of another control circuit of a BMS according to some embodiments of the present disclosure.

FIG. 3 shows a schematic structural diagram of an electric vehicle according to some embodiments of the present disclosure.

### DETAILED DESCRIPTION

The present disclose proposes following solutions.

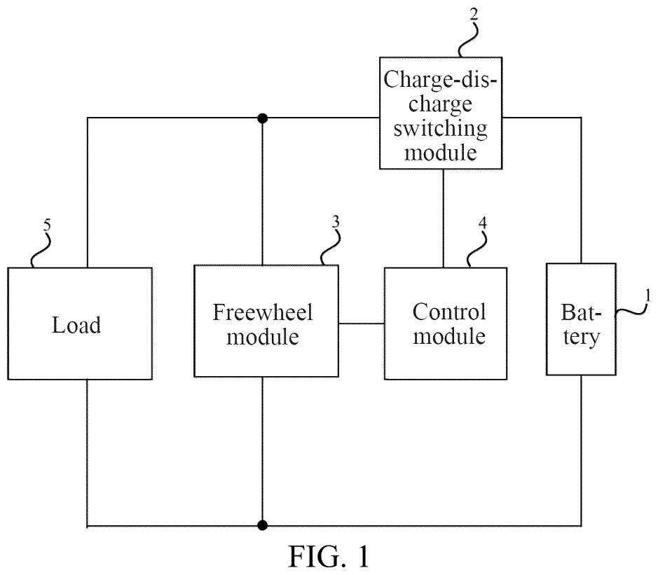

FIG. 1 shows a schematic structural diagram of a control circuit of an BMS according to some embodiments of the present disclosure. Referring to FIG. 1, the control circuit 10 of the BMS according to the embodiments of the present disclosure may include: a charge-discharge switching module 2, a freewheel module 3, and a control module 4, where the charge-discharge switching module 2 may be connected between a battery 1 and a load 5; the freewheel module 3 may be connected in parallel with the load 5; the control module 4 may be connected to the charge-discharge switching module 2 and the freewheel module 3, respectively, and configured to generate a first control signal and a second control signal; the charge-discharge switching module 2 may be configured to be turned off in response to the first control signal; and the freewheel module 3 may be activated in response to the second control signal when the charge-discharge switching module 2 is turned off.

Specifically, the battery 1 may include a plurality of groups of battery cells 1 connected in series or in parallel. The charge-discharge switching module 2 may be configured to charge the battery 1 with an external power supply when the charge-discharge switching module 2 is turned on in response to the first control signal of the control module 4. Alternatively, when the charge-discharge switching module 2 is turned on in response to the first control signal, the battery 1 supplies power to the load 5.

The control module 4 may generate a first control signal and a second control signal in response to an operation instruction of a target user. By providing the freewheel module 3 connected in parallel with the load 5, the freewheel module 3 is activated in response to the second control signal of the control module 4 when the charge-discharge switching module 2 is suddenly disconnected.

Illustratively, when the external power supply completes charging the battery 1, the freewheel module 3 is activated at the moment when the charge-discharge switching module 2 is turned off, and the freewheel module 3 forms a path with the load 5. The load 5 may include an equivalent load 5 and a parasitic inductor. Due to the presence of the parasitic inductor, an current of a charging loop cannot be instantaneously abruptly changed. When the charge-discharge switching module 2 is suddenly turned off, the current of the charging circuit forms a loop through the activated freewheel module 3, so that the instantaneous larger current generated at the moment when the charge-discharge switching module 2 is turned off is prevented from impacting the charge-discharge switching module 2 and causing damage to the charge-discharge switching module 2.

Illustratively, when the battery 1 supplies power to the load 5, the freewheel module 3 is activated at the moment when the charge-discharge switching module 2 is turned off, and the freewheel module 3 forms a path with the load 5. Since a discharging loop includes a parasitic inductor, the current of the charging loop cannot be instantaneously abruptly changed. When the charge-discharge switching module 2 is suddenly turned off, the current of the discharging loop forms a loop through the activated freewheel module 3, so that the instantaneous larger current generated at the moment when the charge-discharge switching module 2 is turned off is prevented from impacting the charge-discharge switching module 2 and causing damage to the charge-discharge switching module 2.

The control circuit of the BMS according to the embodiments of the present disclosure includes: the charge-discharge switching module 2 connected between the battery 1 and the load 5; and the freewheel module 3 connected in parallel with the load 5. At the moment when the charge-discharge switching module 2 is turned off, the freewheel module 3 is activated in response to the second control signal when the charge-discharge switching module 2 is turned off. As such, a loop may be formed by the load 5 and the freewheel module 3 to provide a current discharging loop for an instantaneous high current generated at the moment when the charge and discharge switching module 2 is turned off, and preferably prevents the instantaneous high current from impacting the charge and discharge switching module 2. As such, the control circuit of the BMS may effectively reduce a damage to a device resulting from an impact current generated due to suddenly stopping charging or discharging an electric vehicle.

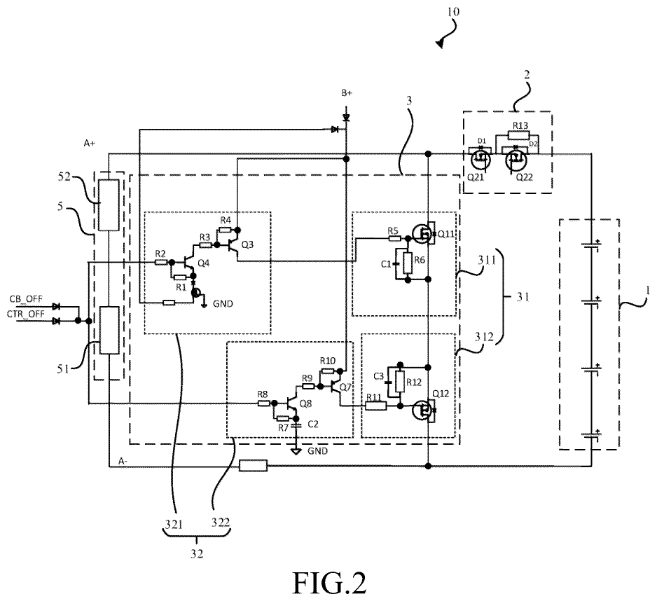

Alternatively, FIG. 2 shows a schematic structural diagram of another control circuit of a BMS according to some embodiments of the present disclosure. On the basis of the above embodiments, referring to FIG. 2, the freewheel module 3 of the control circuit 10 of the BMS according to some embodiments of the present disclosure may include: a switching unit 31 and a driving unit 32; where a first end of the switching unit 31 is connected to a first end of the load 5, and a second end of the switching unit 31 is connected to a second end of the load 5; a first end of the driving unit 32 is connected to a first electrode of the battery 1, a second end of the driving unit 32 is grounded, an input end of the driving unit 32 is connected to the control module 4, and an output end of the driving unit 32 is connected to a control end of the switching unit 31; the driving unit 32 is configured to generate a driving signal in response to the second control signal of the control module 4, and output the driving signal to the switching unit 31; and the switching unit 31 is configured to be turned on in response to the driving signal.

Specifically, the driving unit 32 is connected to the control module 4. The driving unit 32 is turned on in response to the second control signal to output a driving signal. The control end of the switching unit 31 is connected to the output end of the driving unit 32, so that the switching unit 31 is turned on according to the driving signal received by the control end of the switching unit 31.

Illustratively, when the battery 1 is normally charged or discharged, or when the battery 1 is not charged or discharged, the driving unit 32 does not output a driving signal, the switching unit 31 remains in an off state, and the freewheel module 3 is not activated. When the battery 1 supplies power to the load 5 or the power supply charges the battery 1, the charge-discharge switching module 2 is turned off, the driving unit 32 outputs a driving signal, the switching unit 31 remains in an on state, and the freewheel module 3 is activated.

When the driving unit 32 is turned on in response to the second control signal, the driving unit 32 outputs a driving signal to the switching unit 31 to drive the switching unit 31 to be turned on. As such, when the charge-discharge switching module 2 is suddenly turned off, the freewheel module 3 is activated, so that the freewheel module 3 forms a path with the load 5, thereby preventing the instantaneous larger current generated at the moment when the charge-discharge switching module 2 is turned off from impacting the charge-discharge switching module 2 and causing damage to the charge-discharge switching module 2. In addition, the driving unit 32 can provide a higher driving voltage to the switching unit 31 of the freewheel module 3, and can keep the switching unit 31 to be turned on for a long time, so that the instantaneous larger current generated at the moment when the charge-discharge switching module 2 is turned off is discharged through the discharging loop, thereby further improving the protective effect of the freewheel module 3 on the charge-discharge switching module 2.

Alternatively, on the basis of the above-described embodiments, still referring to FIGS. 1 and 2, the load 5 may include: an external equivalent load 51 and a parasitic equivalent inductor 52 connected in series with the external equivalent load 51. The switching unit 31 may include: a first switching unit 311 and a second switching unit 312. The driving unit 32 may include: a first driving unit 321 and a second driving unit 322. A first end of the first switching unit 311 is connected to a first end of the parasitic equivalent inductor 52, and a second end of the first switching unit 311 is connected to a first end of the second switching unit 312. A control end of the first switching unit 311 is connected to an output end of the first driving unit 321. A second end of the second switching unit 312 is grounded, and a control end of the second switching unit 312 is connected to an output end of the second driving unit 322. A first end of the first driving unit 321 is connected to a first end of the second driving unit 322 for connection to the first electrode of the battery 1, and a second end of the first driving unit 321 and a second end of the second driving unit 322 are grounded. The control end of the first driving unit 321 and the control end of the second driving unit 322 are both connected to the control module 4.

Specifically, both the first end of the first driving unit 321 and the first end of the second driving unit 322 are electrically connected to the first electrode of the battery 1, so that the battery 1 supplies power to the first driving unit 321 and the second driving unit 322. It is configured that the switching unit 31 includes the first switching unit 311 and the second switching unit 312, and the driving unit 32 includes the first driving unit 321 and the second driving unit 322. The control end of the first switching unit 311 is connected to the output end of the first driving unit 321, and the control end of the second switching unit 312 is connected to the output end of the second driving unit 322. As such, the freewheel module 3 can be activated when both the first switching unit 311 and the second switching unit 312 are turned on, thereby improving the reliability of the control circuit 10 of the BMS.

Alternatively, on the basis of the above-described embodiments, still referring to FIGS. 1 and 2, the first driving unit 321 may include: a first switch transistor Q4, a second switch transistor Q3, a first resistor R1, a second resistor R2, a third resistor R3, and a fourth resistor R4. A first end of the first switch transistor Q4 is connected to a control end of the second switch transistor Q3, a second end of the first switch transistor Q4 is grounded, the first resistor R1 is connected between the second end of the first switch transistor Q4 and a control end of the first switch transistor Q4, and the second resistor R2 is connected between the control end of the first switch transistor Q4 and the control module 4. A first end of the second switch transistor Q3 is connected to the first electrode of the battery 1, and a second end of the second switch transistor Q3 is connected to the control end of the first switching unit 311. The third resistor R3 is connected between the first end of the first switch transistor Q4 and the control end of the second switch transistor Q3, and the fourth resistor R4 is connected between the first end of the second switch transistor Q3 and the control end of the second switch transistor Q3.

Specifically, the first resistor R1 is configured to supply a voltage between an emitter and a base of the first switch transistor Q4. The second resistor R2 functions as a current limiting protection. The third resistor R3 and the fourth resistor R4 functions as a voltage division. Illustratively, when the second control signal is a high-level signal, the first switch transistor Q4 is turned on, and when the control end of the second switch transistor Q3 is a low-level signal, the second switch transistor Q3 is turned on. Since the first end of the second switch transistor Q3 is connected to the first electrode of the battery 1, for example, a positive electrode, the first driving unit 321 outputs a high-level signal.

Alternatively, on the basis of the above-described embodiments, still referring to FIGS. 1 and 2, the first switching unit 311 may include: a first freewheel switch transistor Q11, a fifth resistor R5, a sixth resistor R6, and a first capacitor C1. A first end of the first freewheel switch transistor Q11 is configured as a first end of the first switching unit 311, and a second end of the first freewheel switch transistor Q11 is configured as a second end of the first switching unit 311. A control end of the first freewheel switch transistor Q11 is connected to an output end of the first driving unit 321. A fifth resistor R5 is connected between the control end of the first freewheel switch transistor Q11 and the output end of the first driving unit 321. The sixth resistor R6 and the first capacitor C1 are connected in parallel between the control end and the second terminal of the first freewheel switch transistor Q11.

Specifically, the fifth resistor R5 and the sixth resistor R6 function as a voltage division. The sixth resistor R6 and the first capacitor C1 function as a voltage stabilization. Illustratively, when a driving signal, such as a high-level signal, is input to the control end of the first freewheel switch transistor Q11, the first end and the second end of the first freewheel switch transistor Q11 are turned on.

Alternatively, on the basis of the above-described embodiments, still referring to FIGS. 1 and 2, the second driving unit 322 may include: a third switch transistor Q8, a fourth switch transistor Q7, a seventh resistor R7, an eighth resistor R8, a ninth resistor R9, a tenth resistor R10, and a second capacitor C2. A first end of the third switch transistor Q8 is connected to a control end of the fourth switch transistor Q7, a second end of the third switch transistor Q8 is grounded, and the seventh resistor R7 is connected between the second end of the third switch transistor Q8 and the control end of the third switch transistor Q8, and the eighth resistor R8 is connected between the control end of the third switch transistor Q8 and the control module 4. A first end of the fourth switch transistor Q7 is connected to a first electrode of the battery 1, and a second end of the fourth switch transistor Q7 is connected to a control end of the third switch transistor Q8. The ninth resistor R9 is connected between the first end of the third switch transistor Q8 and the control end of the fourth switch transistor Q7, and the tenth resistor R10 is connected between the first end of the fourth switch transistor Q7 and the control end of the fourth switch transistor Q7.

Specifically, the seventh resistor R7 is configured to perform current limitation. The eighth resistor R8 and the second capacitor C2 function as filtering. The ninth resistor R9 and the tenth resistor R10 function as a voltage division. Illustratively, when the second control signal is a high-level signal, the third switch transistor Q8 is turned on, and when the control end of the fourth switch transistor Q7 is a low-level signal, the fourth switch transistor Q7 is turned on. Since the first end of the fourth switch transistor Q7 is connected to the first electrode of the battery 1, for example, the positive electrode, the second driving unit 322 outputs a high-level signal.

Alternatively, on the basis of the above-described embodiments, still referring to FIGS. 1 and 2, the second switching unit 312 may include a second freewheel switch transistor Q12, an eleventh resistor R11, a twelfth resistor R12, and a third capacitor C3. A first end of the second freewheel switch transistor Q12 is configured as a first end of the second switching unit 312, and a second end of the second freewheel switch transistor Q12 is configured as a second end of the second switching unit 312. A control end of the second freewheel switch transistor Q12 is connected to an output end of the second driving unit 322. The eleventh resistor R11 is connected between the control end of the second freewheel switch transistor Q12 and the output end of the second driving unit 322. The twelfth resistor R12 and the third capacitor C3 are connected in parallel between the control end and the first end of the second freewheel switch transistor Q12.

Specifically, the eleventh resistor R11 and the twelfth resistor R12 function as a voltage division. The twelfth resistor R12 and the third capacitor C3 function as a voltage stabilization. Illustratively, when a driving signal, such as a high-level signal, is input to the control end of the second freewheel switch transistor Q12, the first end and the second end of the second freewheel switch transistor Q12 are turned on.

Illustratively, when the charge-discharge switching module 2 is suddenly turned off, the first switch transistor Q4 and the second switch transistor Q3 are both turned on in response to the second control signal, so that the first freewheel switch transistor Q11 and the second freewheel switch transistor Q12 are both turned on, to form a current discharging loop by using the external equivalent load 51, the parasitic equivalent inductor 52, the turned-on first freewheel switch transistor Q11, and the turned-on second freewheel switch transistor Q12.

Alternatively, on the basis of the above-described embodiments, still referring to FIGS. 1 and 2, the charge-discharge switching module 2 may include: a charge switch transistor Q21, a discharge switch transistor Q22, a first diode D1, a second diode D2, and a thirteenth resistor R13. A first end of the charge switch transistor Q21 is connected to the load 5, a second end of the charge switch transistor Q21 is connected to a first end of the discharge switch transistor Q22, a second end of the discharge switch transistor Q22 is connected to the battery 1, and a control end of the charge switch transistor Q21 is connected to the control module 4. An anode of the first diode D1 is connected to the second end of the charge switch transistor Q21, and a cathode of the first diode D1 is connected to the first end of the charge switch transistor Q21. An anode of the second diode D2 is connected to a first end of the discharge switch transistor Q22, and a cathode of the second diode D2 and a second end of the discharge switch transistor Q22 is connected to the first electrode of the battery 1. A control end of the discharge switch transistor Q22 is connected to the control module 4. The thirteenth resistor R13 and the second diode D2 are connected in parallel between the first end and the second end of the discharge switch transistor Q22.

Specifically, when the power supply charges the battery 1, the charge switch transistor Q21 is turned on in response to the first control signal, and the discharge switch transistor Q22 is turned off. A charge current flows through the turned-on charge switch transistor Q21 and charges the battery 1 through the thirteenth resistor R13. When the second diode D2 is turned on, the charge current flows through the turned-on charge switch transistor Q21 and charges the battery 1 through the turned-on second diode D2. When the battery 1 is discharged to the load 5, the discharge switch transistor Q22 is turned on in response to the first control signal, and the charge switch transistor Q21 is turned off. A discharge current flows through the turned-on discharge switch transistor Q22 and supplies power to the load 5 through the turned-on first diode D1.

It should be noted that an alternative arrangement of the control circuit 10 of the BMS illustrated in FIG. 2 is not limited in any way. FIG. 2 does not show the control module, and CB_OFF and CTR_OFF in FIG. 2 may represent the output end of the control module. A first electrode A+ and a second electrode A− of the load 5, and the first electrode B+ of the battery are illustratively shown in FIG. 2, which is not limited herein.

Alternatively, on the basis of the above-described embodiments, still referring to FIGS. 1 and 2, the switching unit 31 may include an Metal Oxide Semiconductor (MOS) transistor, and the driving unit 32 may include a triode; and the charge-discharge switching module 2 may comprise an MOS transistor.

Specifically, the switching unit 31 includes an MOS transistor, so that the freewheel module 3 can carry a larger current. The driving unit 32 includes a triode, so that the cost of the driving unit 32 can be reduced. The charge-discharge switching module 2 may include an MOS transistor, so that a charge process and a discharge process of the battery 1 are intelligently controlled. On the other hand, a charge current and a discharge current may flow through the MOS transistor. As such, the safety and reliability of the control circuit 10 of the BMS may be further improved.

Some embodiments of the present disclosure provide a battery management system. The battery management system according to the embodiments of the present disclosure includes the control circuit of the BMS according to any one of the above embodiments, and has the advantageous effect of the control circuit of the BMS according to any one of the above embodiments, which is not repeatedly described herein.

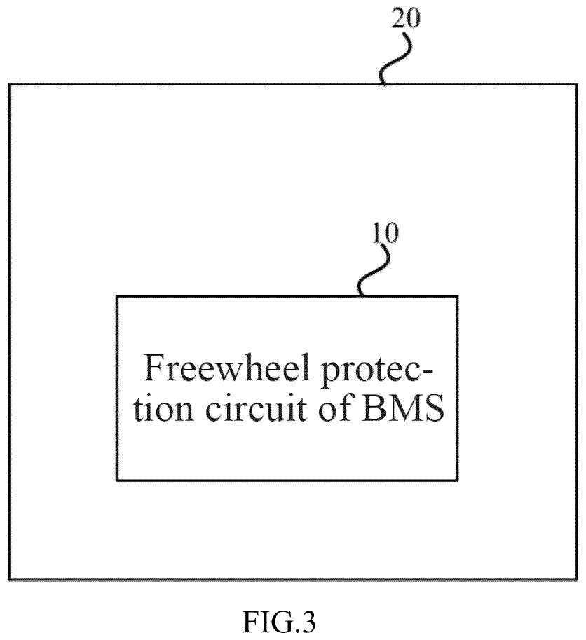

FIG. 3 shows a schematic structural diagram of an electric vehicle according to some embodiments of the present disclosure. On the basis of the above-described embodiments, referring to FIG. 3, the electric vehicle 20 according to the embodiments of the present disclosure includes the control circuit 10 of the BMS according to any one of the above-described embodiments, and has the advantageous effect of the control circuit 10 of the BMS according to any one of the above-described embodiments, which is not repeatedly described herein.

Alternatively, the electric vehicle according to the embodiments of the present disclosure includes the battery management system according to any one of the above-described embodiments, and has the beneficial effect of the battery management system according to any one of the above-described embodiments, which is not repeatedly described herein.

What is claimed is:

1. A control circuit of a Battery Management System (BMS), comprising:
a charge-discharge switching module connected between a battery and a load;
a freewheel module connected in parallel with the load; and
a control module connected to the charge-discharge switching module and the freewheel module, respectively, and configured to generate a first control signal and a second control signal;
wherein the charge-discharge switching module is configured to be turned off in response to the first control signal; and
wherein the freewheel module is configured to be activated in response to the second control signal when the charge-discharge switching module is turned off.

2. The control circuit of claim 1, wherein the freewheel module comprises:
a switching unit having both a first end connected to a first end of the load and a second end connected to a second end of the load; and
a driving unit having a first end connected to a first electrode of the battery, a second end being grounded, an input end connected to the control module, and an output end connected to a control end of the switching unit;
wherein the driving unit is configured to generate a driving signal in response to the second control signal of the control module, and output the driving signal to the switching unit; and
wherein the switching unit is configured to be turned on in response to the driving signal.

3. The control circuit of claim 2, wherein
the load comprises an external equivalent load and a parasitic equivalent inductor connected in series with the external equivalent load;
the switching unit comprises a first switching unit and a second switching unit;
the driving unit comprises a first driving unit and a second driving unit;
a first end of the first switching unit is connected to a first end of the parasitic equivalent inductor, a second end of the first switching unit is connected to a first end of the second switching unit, and a control end of the first switching unit is connected to an output end of the first driving unit;
a second end of the second switching unit is grounded, and a control end of the second switching unit is connected to an output end of the second driving unit;
a first end of the first driving unit is connected to a first end of the second driving unit for connection to the first electrode of the battery, and both a second end of the first driving unit and a second end of the second driving unit are grounded; and
both a control end of the first driving unit and a control end of the second driving unit are connected to the control module.

4. The control circuit of claim 3, wherein the first driving unit comprises: a first switch transistor, a second switch transistor, a first resistor, a second resistor, a third resistor, and a fourth resistor;
a first end of the first switch transistor is connected to a control end of the second switch transistor, a second end of the first switch transistor is grounded, the first resistor is connected between a second end of the first switch transistor and a control end of the first switch transistor, and the second resistor is connected between the control end of the first switch transistor and the control module;
a first end of the second switch transistor is connected to the first electrode of the battery, and a second end of the second switch transistor is connected to the control end of the first switching unit; and
the third resistor is connected between the first end of the first switch transistor and the control end of the second switch transistor, and the fourth resistor is connected between the first end of the second switch transistor and the control end of the second switch transistor.

5. The control circuit of claim 3, wherein the first switching unit comprises: a first freewheel switch transistor, a fifth resistor, a sixth resistor, and a first capacitor;
a first end of the first freewheel switch transistor is configured as the first end of the first switching unit, a second end of the first freewheel switch transistor is configured as the second end of the first switching unit, and a control end of the first freewheel switch transistor is connected to the output end of the first driving unit;
the fifth resistor is connected between the control end of the first freewheel switch transistor and the output end of the first driving unit; and
the sixth resistor and the first capacitor are connected in parallel between the control end of the first freewheel switch transistor and the second end of the first freewheel switch transistor.

6. The control circuit of claim 4, wherein the first switching unit comprises: a first freewheel switch transistor, a fifth resistor, a sixth resistor, and a first capacitor;
a first end of the first freewheel switch transistor is configured as the first end of the first switching unit, a second end of the first freewheel switch transistor is configured as the second end of the first switching unit, and a control end of the first freewheel switch transistor is connected to the output end of the first driving unit;
the fifth resistor is connected between the control end of the first freewheel switch transistor and the output end of the first driving unit; and
the sixth resistor and the first capacitor are connected in parallel between the control end of the first freewheel switch transistor and the second end of the first freewheel switch transistor.

7. The control circuit of claim 4, wherein the second driving unit comprises: a third switch transistor, a fourth switch transistor, a seventh resistor, an eighth resistor, a ninth resistor, a tenth resistor, and a second capacitor;
a first end of the third switch transistor is connected to a control end of the fourth switch transistor, a second end of the third switch transistor is grounded via the second capacitor, the seventh resistor is connected between the second end of the third switch transistor and the control end of the third switch transistor, and the eighth resistor is connected between a control end of the third switch transistor and the control module;
a first end of the fourth switch transistor is connected to the first electrode of the battery, and a second end of the fourth switch transistor is connected to the control end of the third switch transistor; and
the ninth resistor is connected between the first end of the third switch transistor and a control end of the fourth switch transistor, and the tenth resistor is connected between the first end of the fourth switch transistor and the control end of the fourth switch transistor.

8. The control circuit of claim 3, wherein the second switching unit comprises: a second freewheel switch transistor, an eleventh resistor, a twelfth resistor, and a third capacitor;
a first end of the second freewheel switch transistor is configured as the first end of the second switching unit, a second end of the second freewheel switch transistor is configured as the second end of the second switching unit, and a control end of the second freewheel switch transistor is connected to the output end of the second driving unit;
the eleventh resistor is connected between the control end of the second freewheel switch transistor and the output end of the second driving unit; and
the twelfth resistor and the third capacitor are connected in parallel between the control end of the second freewheel switch transistor and the first end of the second freewheel switch transistor.

9. The control circuit of claim 4, wherein the second switching unit comprises: a second freewheel switch transistor, an eleventh resistor, a twelfth resistor, and a third capacitor;
a first end of the second freewheel switch transistor is configured as the first end of the second switching unit, a second end of the second freewheel switch transistor is configured as the second end of the second switching unit, and a control end of the second freewheel switch transistor is connected to the output end of the second driving unit;
the eleventh resistor is connected between the control end of the second freewheel switch transistor and the output end of the second driving unit; and
the twelfth resistor and the third capacitor are connected in parallel between the control end of the second freewheel switch transistor and the first end of the second freewheel switch transistor.

10. The control circuit of claim 3, wherein the charge-discharge switching module comprises: a charge switch transistor, a discharge switch transistor, a first diode, a second diode, and a thirteenth resistor;
a first end of the charge switch transistor is connected to the load, a second end of the charge switch transistor is connected to a first end of the discharge switch transistor, a second end of the discharge switch transistor is connected to the battery, and a control end of the charge switch transistor is connected to the control module;
an anode of the first diode is connected to the second end of the charge switch transistor, and a cathode of the first diode is connected to the first end of the charge switch transistor;
an anode of the second diode is connected to the first end of the discharge switch transistor, and both a cathode of the second diode and the second end of the discharge switch transistor are connected to the first electrode of the battery;
a control end of the discharge switch transistor is connected to the control module; and
the thirteenth resistor is connected between the first end of the discharge switch transistor and the second end of the discharge switch transistor.

11. The control circuit of claim 4, wherein the charge-discharge switching module comprises: a charge switch transistor, a discharge switch transistor, a first diode, a second diode, and a thirteenth resistor;
a first end of the charge switch transistor is connected to the load, a second end of the charge switch transistor is connected to a first end of the discharge switch transistor, a second end of the discharge switch transistor is connected to the battery, and a control end of the charge switch transistor is connected to the control module;
an anode of the first diode is connected to the second end of the charge switch transistor, and a cathode of the first diode is connected to the first end of the charge switch transistor;
an anode of the second diode is connected to the first end of the discharge switch transistor, and both a cathode of the second diode and the second end of the discharge switch transistor are connected to the first electrode of the battery;
a control end of the discharge switch transistor is connected to the control module; and
the thirteenth resistor and the second diode are connected in parallel between the first end of the discharge switch transistor and the second end of the discharge switch transistor.

12. A battery management system, comprising: a control circuit of a Battery Management System (BMS), comprising:
a charge-discharge switching module connected between a battery and a load;
a freewheel module connected in parallel with the load; and
a control module connected to the charge-discharge switching module and the freewheel module, respectively, and configured to generate a first control signal and a second control signal;
wherein the charge-discharge switching module is configured to be turned off in response to the first control signal; and
wherein the freewheel module is configured to be activated in response to the second control signal when the charge-discharge switching module is turned off.

13. The battery management system of claim 12, wherein the freewheel module comprises:
a switching unit having both a first end connected to a first end of the load and a second end connected to a second end of the load; and
a driving unit having a first end connected to a first electrode of the battery, a second end being grounded, an input end connected to the control module, and an output end connected to a control end of the switching unit;
wherein the driving unit is configured to generate a driving signal in response to the second control signal of the control module, and output the driving signal to the switching unit; and
wherein the switching unit is configured to be turned on in response to the driving signal.

14. The battery management system of claim 13, wherein
the load comprises an external equivalent load and a parasitic equivalent inductor connected in series with the external equivalent load;
the switching unit comprises a first switching unit and a second switching unit;
the driving unit comprises a first driving unit and a second driving unit;
a first end of the first switching unit is connected to a first end of the parasitic equivalent inductor, a second end of the first switching unit is connected to a first end of the second switching unit, and a control end of the first switching unit is connected to an output end of the first driving unit;
a second end of the second switching unit is grounded, and a control end of the second switching unit is connected to an output end of the second driving unit;
a first end of the first driving unit is connected to a first end of the second driving unit for connection to the first electrode of the battery, and both a second end of the first driving unit and a second end of the second driving unit are grounded; and
both a control end of the first driving unit and a control end of the second driving unit are connected to the control module.

15. The battery management system of claim 14, wherein the first driving unit comprises: a first switch transistor, a second switch transistor, a first resistor, a second resistor, a third resistor, and a fourth resistor;
a first end of the first switch transistor is connected to a control end of the second switch transistor, a second end of the first switch transistor is grounded, the first resistor is connected between a second end of the first switch transistor and a control end of the first switch transistor, and the second resistor is connected between the control end of the first switch transistor and the control module;
a first end of the second switch transistor is connected to the first electrode of the battery, and a second end of the second switch transistor is connected to the control end of the first switching unit; and
the third resistor is connected between the first end of the first switch transistor and the control end of the second switch transistor, and the fourth resistor is connected between the first end of the second switch transistor and the control end of the second switch transistor.

16. The battery management system of claim 14, wherein the first switching unit comprises: a first freewheel switch transistor, a fifth resistor, a sixth resistor, and a first capacitor;
a first end of the first freewheel switch transistor is configured as the first end of the first switching unit, a second end of the first freewheel switch transistor is configured as the second end of the first switching unit, and a control end of the first freewheel switch transistor is connected to the output end of the first driving unit;
the fifth resistor is connected between the control end of the first freewheel switch transistor and the output end of the first driving unit; and
the sixth resistor and the first capacitor are connected in parallel between the control end of the first freewheel switch transistor and the second end of the first freewheel switch transistor.

17. The battery management system of claim 15, wherein the second driving unit comprises: a third switch transistor, a fourth switch transistor, a seventh resistor, an eighth resistor, a ninth resistor, a tenth resistor, and a second capacitor;
a first end of the third switch transistor is connected to a control end of the fourth switch transistor, a second end of the third switch transistor is grounded via the second capacitor, the seventh resistor is connected between the second end of the third switch transistor and the control end of the third switch transistor, and the eighth resistor is connected between a control end of the third switch transistor and the control module;
a first end of the fourth switch transistor is connected to the first electrode of the battery, and a second end of the fourth switch transistor is connected to the control end of the third switch transistor; and
the ninth resistor is connected between the first end of the third switch transistor and a control end of the fourth switch transistor, and the tenth resistor is connected between the first end of the fourth switch transistor and the control end of the fourth switch transistor.

18. The battery management system of claim 14, wherein the second switching unit comprises: a second freewheel switch transistor, an eleventh resistor, a twelfth resistor, and a third capacitor;
a first end of the second freewheel switch transistor is configured as the first end of the second switching unit, a second end of the second freewheel switch transistor is configured as the second end of the second switching unit, and a control end of the second freewheel switch transistor is connected to the output end of the second driving unit;
the eleventh resistor is connected between the control end of the second freewheel switch transistor and the output end of the second driving unit; and
the twelfth resistor and the third capacitor are connected in parallel between the control end of the second freewheel switch transistor and the first end of the second freewheel switch transistor.

19. An electric vehicle, comprising: a control circuit of a Battery Management System (BMS), comprising:
a charge-discharge switching module connected between a battery and a load;
a freewheel module connected in parallel with the load; and
a control module connected to the charge-discharge switching module and the freewheel module, respectively, and configured to generate a first control signal and a second control signal;
wherein the charge-discharge switching module is configured to be turned off in response to the first control signal; and
wherein the freewheel module is configured to be activated in response to the second control signal when the charge-discharge switching module is turned off.

20. An electric vehicle, comprising: the battery management system of claim 12.
